(19) United States
(12) Patent Application Publication
(10) Pub. No.: US 2024/0353259 A1
(43) Pub. Date: Oct. 24, 2024

(54) Binned Spectrographic Analyzer of Pulses within a Signal

(71) Applicant: The United States of America, as represented by the Secretary of the Navy, San Diego, CA (US)

(72) Inventors: Dwane F. Sample, San Diego, CA (US); Nathan J. Gengler, San Diego, CA (US); Peter Magee, San Diego, CA (US)

(21) Appl. No.: 18/303,814

(22) Filed: Apr. 20, 2023

(51) Int. Cl. G01J 3/28; G01J 3/02

(52) U.S. Cl. CPC G01J 3/2803; G01J 3/0227; G01J 2003/2859

(57) ABSTRACT

A spectrographic analyzer of pulses within a signal includes a data interface, an edge detection filter, a delay buffer, an integrator, and a histogram buffer. The data interface duplicates a stream of digital amplitude samples for the signal into a first and second stream. The edge detection filter determines the beginning and end of each pulse within the first stream of the digital amplitude samples. The delay buffer delays the second stream by a duration sufficient for the edge detection filter to determine both the beginning and end of each pulse. The integrator sums a respective amplitude total for each pulse. The respective amplitude total sums the digital amplitude samples between the beginning and end of each pulse in the second stream as delayed by the delay buffer. The histogram buffer maintains bins and increments a respective one of the bins encompassing the respective amplitude total for each pulse.

### FEDERALLY SPONSORED RESEARCH AND DEVELOPMENT

The United States Government has ownership rights in this invention. Licensing and technical inquiries may be directed to the Office of Research and Technical Applications, Naval Information Warfare Center Pacific, Code 72120, San Diego, CA, 92152; voice (619) 553-5118; NIWC_Pacific_T2@us.navy.mil. Reference Navy Case Number 112440.

### BACKGROUND OF THE INVENTION

A spectrographic analyzer determines a spectrum for detected events. For example, a spectrographic analyzer of gamma rays determines the energy of each individual gamma ray and produces an energy spectrum over a sampling of detected gamma rays. However, in a gamma radiation field with high flux, measurement of the energy of each gamma ray requires sensitive detectors that convert each gamma ray into an extremely short pulse, because otherwise the detected gamma rays overlap and blur together, making extraction of the energy of individual gamma rays impossible. Thus, a spectrographic analyzer of a gamma radiation field with high flux requires measurement of a large number of extremely short pulses. The required high sample rate requires high-powered computer processing, and even when high-powered computer processing is dedicated to the spectrographic analyzer, the high-powered computer processing typically cannot keep up with the real-time processing demands. There is a general need for a spectrographic analyzer that robustly and accurately measures a high flux of detected events.

### SUMMARY OF THE INVENTION

A spectrographic analyzer of pulses within a signal includes a data interface, an edge detection filter, a delay buffer, an integrator, and a histogram buffer. The data interface duplicates a stream of digital amplitude samples for the signal into a first and second stream. The edge detection filter determines the beginning and end of each pulse within the first stream of the digital amplitude samples. The delay buffer delays the second stream by a duration sufficient for the edge detection filter to determine both the beginning and end of each pulse. The integrator sums a respective amplitude total for each pulse. The respective amplitude total sums the digital amplitude samples between the beginning and end of each pulse in the second stream as delayed by the delay buffer. The histogram buffer maintains bins and increments a respective one of the bins encompassing the respective amplitude total for each pulse.

### BRIEF DESCRIPTION OF DRAWINGS

Throughout the several views, like elements are referenced using like references. The elements in the figures are not drawn to scale and some dimensions are exaggerated for clarity.

FIG. 1 is a block diagram of a binned spectrographic analyzer of pulses within a signal in accordance with an embodiment of the invention.

FIG. 2 is example waveforms for a binned spectrographic analyzer of pulses within a signal in accordance with an embodiment of the invention.

FIG. 3A-C are example waveforms illustrating counting of potentially overlapping pulses in accordance with an embodiment of the invention.

### DETAILED DESCRIPTION

The disclosed systems and methods below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other systems and methods described herein as will be understood by one of ordinary skill in the art unless otherwise stated specifically.

The inventors have discovered that a spectrographic analyzer for a high flux of detected events can be achieved with pipelined hardware, which limits the processing needed in a general purpose computer to handling the user interface for the spectrographic analyzer. A sensitive detector converts each gamma ray into an extremely short pulse, and a high-speed analog-to digital converter (ADC) converts each extremely short pulse into a sequence of digital samples. The inventors have further discovered a technique for detection and circumvention of overlapping pulses that limits the required sensitivity of the detectors because frequently overlapping pulses are detected and eliminated from the measured spectrum. This technique of detection and circumvention of overlapping pulses is readily implemented in the pipelined hardware. The inventors have yet further discovered improved measurement accuracy from measuring the area under each extremely short pulse, instead of measuring of the peak amplitude of each extremely short pulse. The integration of this pulse area measurement suppresses quantization and other noise in the digital samples, increasing measurement accuracy, and is readily implemented in the pipelined hardware too. In one embodiment, the spectrographic analyzer includes a high-speed analog-to-digital converter (ADC), the pipelined hardware implemented in a field programmable gate array (FPGA), and the user interface implemented using a processor that is either internal or external to the FPGA.

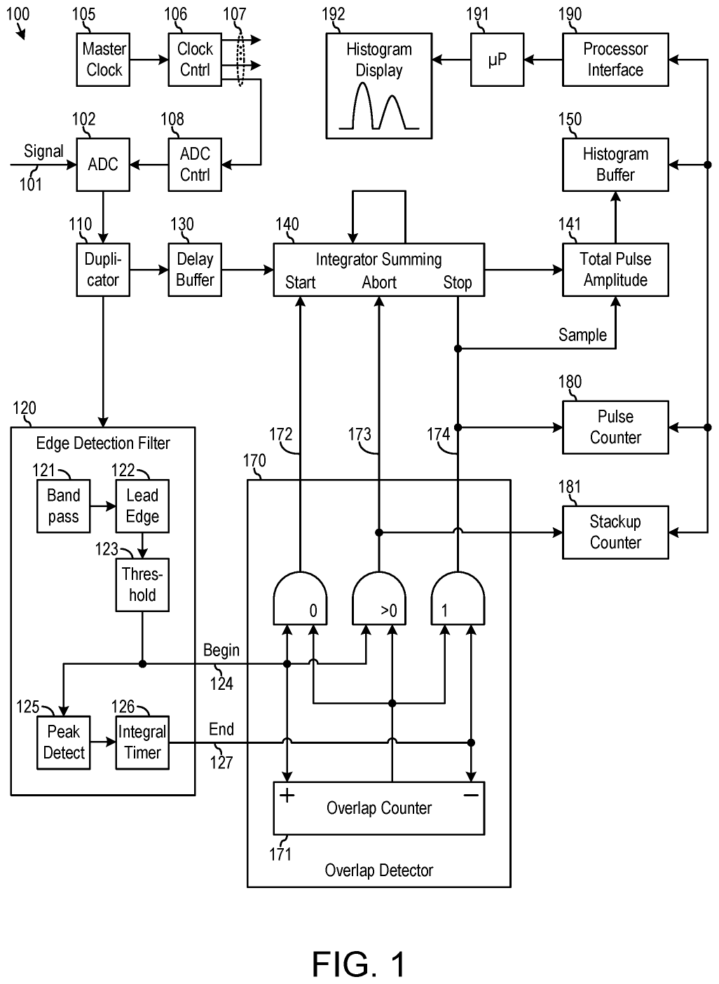

FIG. 1 is a block diagram of a binned spectrographic analyzer 100 of pulses within a signal 101 in accordance with an embodiment of the invention. Typically, the signal 101 is an analog signal and an analog-to-digital converter (ADC) 102 converts the analog signal 101 into an input stream of digital amplitude samples. In another embodiment, the signal 101 is already a digital signal and ADC 102 is omitted.

The master clock 105 provides a reference clock from which clock control 106 generates and fans out multiple clock signals 107 having various phases and typically lower frequencies for maintaining synchronization between the components of the spectrographic analyzer 100. ADC clock control 108 generates specific clock signals and other control signals for the ADC 102.

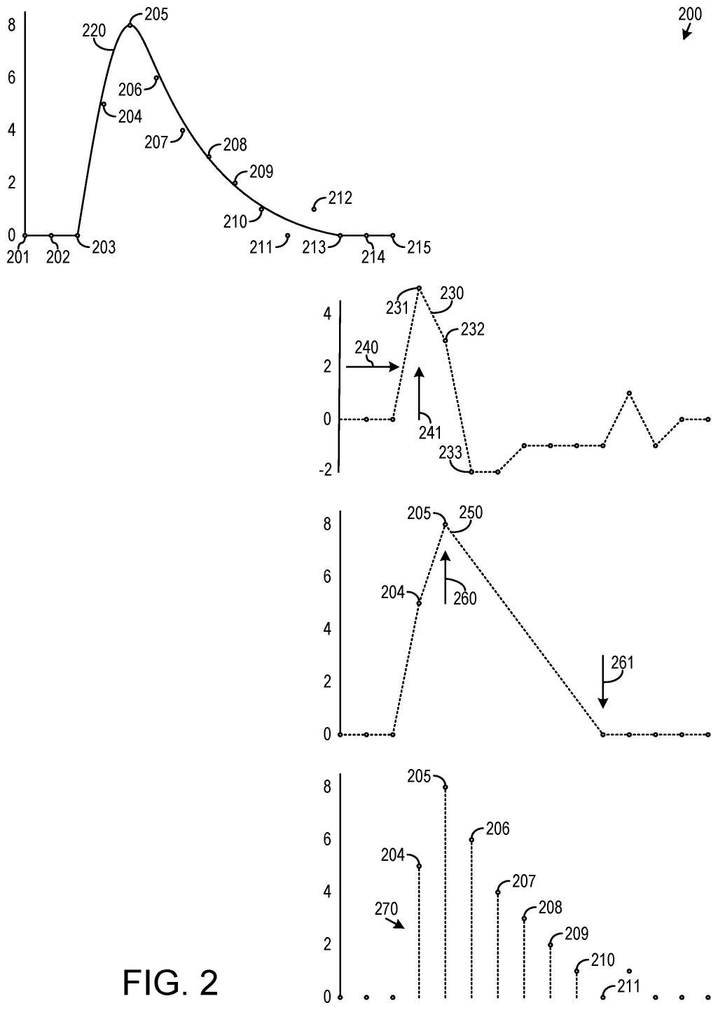

FIG. 2 is example waveforms 200 for a binned spectrographic analyzer of pulses within a signal in accordance with an embodiment of the invention. The waveforms 200 include pulse 220 of the signal, filter response 230, pulse-peak waveform 250, and pulse area 270 of the pulse 220. The pulse area 270 measures the intensity of the pulse 220.

The pulse 220 of FIG. 2 shows a typical pulse within the signal 101. The typical pulse has a sharp leading edge and then exponentially decays. The ADC 102 converts the pulse 220 of an analog signal 101 into the input stream of the digital amplitude samples 201, 202, 203, 204, 205, 206, 207, 208, 209, 210, 211, 212, 213, 214, and 215. Due to quantization and noise, the digital amplitude samples 201 through 215 do not exactly follow pulse 220 of the analog signal 101.

Returning to FIG. 1, the spectrographic analyzer 100 of pulses within a signal 101 includes a data interface 110, an edge detection filter 120, a delay buffer 130, an integrator 140, and a histogram buffer 150. The data interface 110 duplicates the input stream of digital amplitude samples for the signal 101 into two synchronized streams of the digital amplitude samples respectively delivered to the edge detection filter 120 and the delay buffer 130. The edge detection filter 120 determines a beginning 124 and an end 127 of each of the pulses within the first duplicated stream of the digital amplitude samples from data interface 110. The delay buffer 130 delays the second duplicated stream of the digital samples by a duration sufficient for the edge detection filter 120 to determine both the beginning 124 and the end 127 of each of the pulses. The integrator 140 sums a respective amplitude total for each of the pulses. The respective amplitude total sums the digital amplitude samples between the beginning 124 and the end 127 of each of the pulses in the second duplicated stream as delayed by the delay buffer 130. The histogram buffer 150 maintains histogram bins and increments a respective one of the bins encompassing the respective amplitude total for each of the pulses.

In one embodiment, the edge detection filter 120 includes a differentiating filter 122 and threshold comparator 123. It will be appreciated that the differentiating filter 122 is more generally a proportional, integral, and differentiating (PID) filter, but the differentiating term typically dominates the filter response. The differentiating filter 122 detects a discerned leading edge rate of the pulses. The threshold comparator 123 determines the beginning 124 of each pulse from the filter response of the differentiating filter 122.

In FIG. 2, for discussion purposes, the filter response 230 of the differentiating filter 122 is a simple differentiating filter where each sample of the filter response 230 is the difference between two adjacent digital amplitude samples of pulse 220. For example, sample 231 of filter response 230 is the difference between digital amplitude sample 204 and digital amplitude sample 203 of pulse 220, and sample 232 of filter response 230 is the difference between digital amplitude sample 205 and digital amplitude sample 204 of pulse 220. To depict a delay through the edge detection filter 120, the filter response 230 is shown time shifted to the right relative to pulse 220. The delay buffer 130 provides a delay corresponding to the delay through the edge detection filter 120, and this synchronizes the stream of digital amplitude samples 201 through 215 with the beginning 241 and the end 261 of each pulse 220.

The threshold comparator 123 determines the beginning 241 of each pulse 220 upon the discerned leading edge rate of the filter response 230 from the differentiating filter 122 crossing a threshold 240. In particular, because sample 231 of filter response 230 rises above threshold 240, the beginning 241 of pulse 220 is at sample 231, which corresponds to sample 204 of pulse 220.

Returning to FIG. 1, in one embodiment, the edge detection filter 120 further includes a digital bandpass filter 121 with a center of a bandpass corresponding to an expected leading edge rate of the pulses. This accentuates the faster leading edge rate of the pulses relative to the slower exponential decay of the pulses, and filters out most the noise, which generally has a wide bandwidth and hence only a small portion of the noise falls within the bandpass of the bandpass filter 121. Thus, even though the differentiating filter 122 usually amplifies the portion of the noise falling within the bandpass of the bandpass filter 121, noise is reduced or limited with the combination of the bandpass filter 121 and the differentiating filter 122. The differentiating filter 122 detects the discerned leading edge rate from an output of the digital bandpass filter 121. In FIG. 2, this modifies the filter response 230 so that sample 233 and subsequent samples have values much closer to zero, so the filter response 230 becomes a near-impulse peak at the leading edge of each pulse 220. This increases the robustness of the edge detection filter 120 detecting the beginning 241 of each pulse 220.

In one embodiment, the edge detection filter 120 further includes a peak detector 125 and an integration timer 126. After detecting the beginning 124 of each particular pulse, the peak detector 125 and the integration timer 126 determine the end 127 of that particular pulse. The peak detector 125 detects a pulse peak following the beginning 124 of each of the pulses. The integration timer 126 sets the end 127 of each of the pulses to a respective duration after the pulse peak of each of the pulses.

In FIG. 2, the peak detector 125 initializes the pulse-peak waveform 250 to the digital amplitude sample 204 of pulse 220 at the beginning 241 of the pulse 220. However, the next digital amplitude sample 205 of pulse 220 has a higher amplitude, so the peak detector 125 sets the pulse peak 260 to digital amplitude sample 205. This continues so long as the pulse 220 monotonically increases after the beginning 241 of the pulse 220. The pulse peak 260 is the latest digital amplitude sample 205 after the beginning 241 of the pulse 220 for which the next digital amplitude sample 206 has a lower amplitude.

If instead FIG. 2 were modified so digital amplitude samples 205 and 206 have the same quantized value, the pulse peak 260 would be the later digital amplitude sample 206. This would not change the amplitude of the pulse peak 260, but would delay when integration timer 126 starts counting the duration until the end 261 of each pulse 220.

In an adaptive embodiment, the duration between the beginning 241 and the end 261 of the pulse 220 is proportional to an amplitude of the pulse peak 260. Typically, the exponential decay of pulse 220 has a dominate time constant, and the duration is proportional to this dominate time constant times the value of the digital amplitude sample 205 of the pulse peak 260. Calculation of the duration is similar when there are multiple significant time constants. The time constant depends upon factors including the effective impedance of each of the scintillation device, the optical light collection elements including magnifying lenses, and their associated electronics. Alternatively, the duration of the pulse 220 is the projected time interval needed for the pulse 220 to decay from the digital amplitude sample 205 of the pulse peak 260 to an expected or measured noise floor at the expected or measured time constant or constants. The measured noise floor is variable and based on samples between pulses and the measured time constant or constants is variable and measured from pulses prior to pulse 220. The integration timer 126 determines the duration of the pulse 220 either through mathematical calculations or through lookup tables.

In a simplified non-adaptive embodiment having a lower pulse rate capacity, the duration of the pulse 220 is not based on the amplitude of the pulse peak 260, but is instead fixed near a maximum expected pulse duration of the largest expected pulse.

If the integration timer 126 is implemented as a countdown timer, the pulse-peak waveform 250 between the pulse peak 260 and the end 261 of each pulse 220 is a linear descending ramp representing the current value of the countdown timer. Upon the countdown timer counting down to or below zero, the pulse-peak waveform 250 maintains a value of zero until the beginning 124 of the next pulse is detected upon filter response 230 again upwardly crossing the threshold 240.

The integrator 140 sums a respective amplitude total 141 for each pulse from the digital amplitude samples between the beginning 124 and the end 127 of the pulse in the stream of digital amplitude samples as delayed by the delay buffer 130. The delay buffer 130 synchronizes the stream of digital amplitude samples with the beginning 124 and the end 127 of each pulse. In FIG. 2, the respective amplitude total for the pulse 220 is sum of the digital amplitude samples 204, 205, 206, 207, 208, 209, 210 and 211 inclusively between the beginning 241 and the end 261 of the pulse 220. This gives the area 270 under the pulse 220 and measures the intensity of the pulse 220. The integration of the pulse area measurement suppresses quantization and other noise in the digital samples, increasing measurement accuracy. For example, the quantization noise of digital samples 208 and 209 is positive because they are located above the pulse 220, while the remainder of the digital samples contributing to area 270 have negative or neutral quantization noise. The integration of area 270 reduces noise and increase spectral resolution because, typically, half of the digital samples have positive noise and the other half have cancelling negative noise.

The histogram buffer 150 is coupled to the integrator 140 for incrementing the respective histogram bin encompassing the respective amplitude total 141 for each of the pulses. In one embodiment, a range for the respective amplitude total 141 is a power of two and the respective amplitude total 141 is an address into a random access memory (RAM) within the histogram buffer 150. The histogram bin in the RAM at the address is read, incremented, and written back into the histogram bin. To achieve the range that is a power of two, the respective amplitude total 141 is potentially scaled and offset, and then the most significant bits are extracted. Alternatively, sequential searching or a content addressable memory accesses the incremented bin in the histogram buffer 150.

In one embodiment, the spectrographic analyzer 100 includes an overlap detector 170 that determines when a first and second pulse overlap, with the beginning of the second pulse after the beginning of the first pulse and before the end of the first pulse. An overlap counter 171 increments upon the beginning 124 of each of the pulses, and decrements not below zero upon the end 127 of each of the pulses. Thus, the value of the overlap counter 171 is the number of currently overlapping pulses.

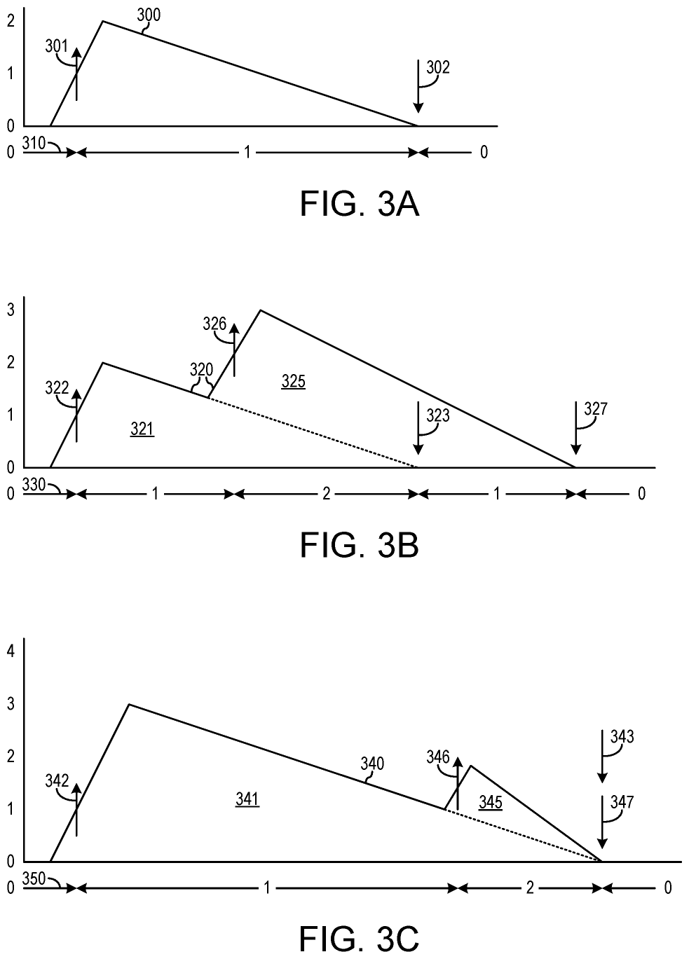

FIG. 3A-C are example waveforms 300, 320, and 340 illustrating counting of potentially overlapping pulses in accordance with an embodiment of the invention. FIG. 3A illustrates a waveform 300 of a pulse that does not overlap another pulse. The pulse of waveform 300 has a start 301 and an end 302. The waveform 300 is simplified to show how the edge detection filter 120 tracks the pulse, with a leading edge rising to a peak detected by the peak detector 125 and a linear trailing edge corresponding to a value of a countdown integration timer 126. For this isolated pulse not overlapping with other pulses, the overlap counter 310 increments from zero to one at the start 301 of the pulse and decrements from one back to zero at the end 302 of the pulse.

FIG. 3B is an example waveform 320 illustrating counting of two overlapping pulses 321 and 325 having equal amplitudes. The waveforms 320 is the stackup of the overlapping pulses 321 and 325 with an amplitude of the waveform 320 equaling the sum of the individual amplitudes of the pulses 321 and 325 if they were not overlapping pulses. The start 322 of the first pulse 321 occurs when the leading edge rate crosses a threshold. The start 326 of the second pulse 325 occurs because the leading edge rate also crosses the threshold. The example waveform 320 illustrates a fixed duration between a start 322 and an end 323 of pulse 321, and the same fixed duration between a start 326 and an end 327 of pulse 325. The overlap counter 330 increments from zero to one at the start 322 of the first pulse 321, increments further from one to two at the start 326 of the second pulse 325, decrements from two to one at the end 323 of the first pulse 321, and finally decrements from one to zero at the end 327 of the second pulse 325.

FIG. 3C is an example waveform 340 illustrating overlap counting for a first pulse 341 of large amplitude and a second overlapping pulse 345 of small amplitude. The example waveform 340 illustrates a variable pulse duration that is a function of the peak amplitude of each pulse 341 and 345. Thus, the duration between a start 342 and an end 343 of the larger first pulse 341 is longer than a duration between a start 346 and an end 347 of the smaller second pulse 345. The example waveform 340 illustrates the unlikely scenario where the end 343 of the first pulse 341 coincides with the end 347 of the second pulse 345. This could occur, for example, when the variable pulse duration is proportional to a difference between each pulse peak and a measured noise floor, and the second pulse 345 has a leading edge rate that just barely crosses the threshold above the measured noise floor. The overlap counter 350 increments at the starts 342 and 346 of the pulses 341 and 345, and decreases from two to zero at the coincident ends 343 and 347 of the pulses 341 and 345.

The scenario of FIG. 3C might never occur depending upon the specific function determining the variable pulse duration. It is also possible the end 347 of the second pulse 345 occurs before the end 343 of the first pulse 345 in a particular embodiment. In FIG. 1, to handle such an embodiment, the integral timer 126 sets its countdown value to the maximum of its current countdown value and the incoming duration for a subsequent pulse from the peak detector 125, and clears the overlap counter 171 upon each expiration of the integral timer 126.

Returning to FIG. 1, the overlap detector 170 generates a start signal 172, an abort signal 173, and a stop signal 174. The start signal 172 is asserted at the beginning 124 of each pulse that increments the overlap counter 171 from a current value of zero to an incremented value of one. The start signal 172 starts the integrator 140 summing digital amplitude samples. The abort signal 173 is asserted at the beginning 124 of each pulse that increments the overlap counter 171 further beyond a value of one. The abort signal 173 aborts summing in the integrator 140 and clears the running total in the integrator 140. The stop signal 174 is asserted at the end 127 of each pulse that decrements the overlap counter 171 from a current value of one to a decremented value of zero. The stop signal 174 samples the running total from the integrator 140 into the respective amplitude total 141, and simultaneously clears the running total in the integrator 140 for the next pulse.

When a first and second pulse overlap, the overlap detector 170 does not generate a start signal 172 at the beginning 124 of the second pulse because the value of the overlap counter 171 is not zero. In addition, because the second pulse overlaps the first pulse, the overlap detector 170 generates an abort signal 173 at the beginning 124 of the second pulse in parallel because the value of the overlap counter 171 is non-zero. Thus, because the first and second pulses overlap, the integrator 140 does not even start summing a running total for the second pulse and hence the histogram buffer 150 does not record the second pulse. Also, because the first and second pulses overlap, the integrator 140 aborts summing a running total for the first pulse and hence the histogram buffer 150 does not record the first pulse.

The integrator 140 is coupled to the overlap detector 170 and the delay buffer 130. The integrator 140 sums up the respective amplitude total 141 for each pulse from the digital amplitude samples between the start signal 172 and the stop signal 174 of each pulse in the stream as delayed by the delay buffer 130, unless aborted by the abort signal 173. The respective amplitude total 141 is effectively cleared upon the abort signal 173 or after the stop signal 174 so that the integrator 140 is ready to begin summing the respective amplitude total 141 at the beginning 124 of a next pulse in the stream as delayed by the delay buffer 130.

The histogram buffer 150 is coupled to the integrator 140 for incrementing, upon the stop signal 174, a respective one of the bins encompassing the respective amplitude total 141 for each pulse.

In one embodiment, the spectrographic analyzer 100 includes a pulse counter 180 and a stackup counter 181. The pulse counter 180 counts the pulses successfully recorded in the bins of the histogram buffer 150. The stackup counter 181 increments whenever two pulses overlap. The values of the pulse counter 180 and the stackup counter 181 together provide a confidence for the pulses recorded in the histogram buffer 150. The values of the pulse counter 180 and the stackup counter 181 also provide an estimate of the dead time over the course of a measurement cycle, with the dead time being the time interval within the measurement cycle occupied by overlapping pulses.

In one embodiment, the spectrographic analyzer 100 includes a processor interface 190 for providing access to the histogram buffer 150, the stackup counter 181, and the pulse counter 180. A processor 191 is programmed to present a histogram of the pulses recorded in the histogram buffer 150 on a display 192, and is further programmed to present on the display 192 a quality factor derived from values of the stackup counter 181 and the pulse counter 180. In one embodiment, the processor 191 is programmed to accept user input at the display 192 for controlling the spectrographic analyzer 100, such as starting and stopping a histogram measurement cycle, or controlling the scale and offset applied to the amplitude total 141 for determining the appropriate bin for each pulse in the histogram buffer 150.

Preferably, the spectrographic analyzer 100 is mostly implemented in pipelined hardware, such as a field programmable gate array (FPGA), to achieve a low burden on the processor 191, which is either internal to the FPGA or external, and to achieve robust measurement of short-duration and frequently overlapping pulses within a high sample rate signal 101 from detection of gamma rays. The pipelined hardware in the FPGA is combined with an external high sample rate ADC 102 to achieve a high-count-rate gamma-ray spectrographic analyzer 100.

In one embodiment, the spectrographic analyzer 100 includes multiple channels each containing an instance of the components shown in FIG. 1, except that the master clock 105 and the processor 191 with display 192 are shared. With separate event detectors for each instance, the multi-channel spectrographic analyzer 100 can detect coherence effects, such as simultaneous emission of anti-parallel gamma rays having equal energies.

From the above description of a Binned Spectrographic Analyzer of Pulses within a Signal, it is manifest that various techniques may be used for implementing the concepts of analyzer 100 without departing from the scope of the claims. The described embodiments are to be considered in all respects as illustrative and not restrictive. The analyzer 100 disclosed herein may be practiced in the absence of any element that is not specifically claimed and/or disclosed herein. It should also be understood that analyzer 100 is not limited to the particular embodiments described herein, but is capable of many embodiments without departing from the scope of the claims.

We claim:

1. A spectrographic analyzer of a plurality of pulses within a signal, comprising:
a data interface for duplicating an input stream of a plurality of digital amplitude samples for the signal into a first and second stream of the digital amplitude samples;
an edge detection filter for determining a beginning and an end of each of the pulses within the first stream of the digital amplitude samples;
a delay buffer for delaying the second stream of the digital samples by a duration sufficient for the edge detection filter to determine both the beginning and the end of each of the pulses;
an integrator for summing a respective amplitude total for each of the pulses, the respective amplitude total from summing the digital amplitude samples between the beginning and the end of each of the pulses in the second stream as delayed by the delay buffer; and
a histogram buffer for maintaining a plurality of bins and for incrementing a respective one of the bins encompassing the respective amplitude total for each of the pulses.

2. The spectrographic analyzer of claim 1, further comprising:
an analog-to-digital converter (ADC) for converting the signal, which is an analog signal, into the input stream of the digital amplitude samples.

3. The spectrographic analyzer of claim 1, wherein the edge detection filter includes:
a differentiating filter for detecting a discerned leading edge rate of the pulses; and
a threshold comparator for determining the beginning of each of the pulses upon the discerned leading edge rate from the differentiating filter crossing a threshold.

4. The spectrographic analyzer of claim 3, wherein the edge detection filter further includes:
a digital bandpass filter with a center of a bandpass corresponding to an expected leading edge rate of the pulses, the differentiating filter detecting the discerned leading edge rate from an output of the digital bandpass filter.

5. The spectrographic analyzer of claim 3, wherein the edge detection filter further includes:
a peak detector for detecting a pulse peak following the beginning of each of the pulses; and
an integration timer for setting the end of each of the pulses to a respective duration after the pulse peak.

6. The spectrographic analyzer of claim 5, wherein the respective duration is proportional to an amplitude of the pulse peak of each of the pulses.

7. The spectrographic analyzer of claim 1, further comprising:
an overlap detector for determining when a first and second pulse of the pulses overlap with the beginning of the second pulse after the beginning of the first pulse and before the end of the first pulse.

8. The spectrographic analyzer of claim 7, further comprising:
a stackup counter for incrementing when the first and second pulses overlap.

9. The spectrographic analyzer of claim 7, wherein, because the first and second pulses overlap, the integrator aborts summing the respective amplitude total for the first pulse and the histogram buffer does not record the first pulse.

10. The spectrographic analyzer of claim 9, wherein, because the first and second pulses overlap, the integrator does not even start summing the respective amplitude total for the second pulse and the histogram buffer does not record the second pulse.

11. The spectrographic analyzer of claim 10, wherein the edge detection filter includes:
a digital bandpass filter with a center of a bandpass corresponding to an expected leading edge rate of the pulses;
a differentiating filter for detecting a discerned leading edge rate of the pulses from an output of the digital bandpass filter; and
a threshold comparator for determining the beginning of each of the pulses upon the discerned leading edge rate from the differentiating filter crossing a threshold.

12. The spectrographic analyzer of claim 1, further comprising:
an overlap detector with an overlap counter for incrementing upon the beginning of each of the pulses, and for decrementing not below zero upon the end of each of the pulses,
wherein the overlap detector is for generating a start, abort, and stop signal, the start signal asserted at the beginning of each of the pulses that increments the overlap counter from zero to one, the abort signal asserted at the beginning of each of the pulses that increments the overlap counter further, and the stop signal asserted at the end of each of the pulses that decrements the overlap counter from one to zero.

13. The spectrographic analyzer of claim 12, wherein the integrator is coupled to the overlap detector and the delay buffer for:
summing the respective amplitude total for each of the pulses from the digital amplitude samples between the start and stop signals of each of the pulses in the second stream as delayed by the delay buffer, unless aborted by the abort signal; and
clearing the respective amplitude total upon the abort signal or after the stop signal so that the integrator is ready to begin summing the respective amplitude total at the beginning of a next one of the pulses in the second stream as delayed by the delay buffer.

14. The spectrographic analyzer of claim 13, wherein the histogram buffer is coupled to the integrator for incrementing, upon the stop signal, the respective one of the bins encompassing the respective amplitude total for each of the pulses.

15. The spectrographic analyzer of claim 14, further comprising:
a pulse counter for counting the pulses recorded in the bins.

16. The spectrographic analyzer of claim 15, further comprising:
a stackup counter for incrementing when two of the pulses overlap.

17. The spectrographic analyzer of claim 16, further comprising:
a processor interface for providing access to the histogram buffer, the stackup counter, and the pulse counter; and
a processor programmed to present on a display a histogram of the pulses recorded in the histogram buffer, and further programmed to present on the display a quality factor derived from the stackup counter and the pulse counter.

18. The spectrographic analyzer of claim 1, further comprising:
a pulse counter for counting the pulses recorded in the bins.

19. The spectrographic analyzer of claim 18, further comprising:
a stackup counter for incrementing when two of the pulses overlap.

20. The spectrographic analyzer of claim 1, further comprising:
a stackup counter for incrementing when two of the pulses overlap.
